(19) United States
(12) Patent Application Publication
(10) Pub. No.: US 2004/0197541 A1
(43) Pub. Date: Oct. 7, 2004

(54) Selective electroless deposition and interconnects made therefrom

(76) Inventors: Joseph Zahka, Andover, MA (US); Jieh-Hwa Shyu, Andover, MA (US); Brett Belongia, North Andover, MA (US); Larry Yen, Andover, MA (US); John E. Pillion, Brookline, NH (US); Sonan Nguyen, Manchester, NH (US)

Correspondence Address: Timothy J King, Mykrolis Corporation, 129 Concord Road, Billerica, MA, 01821, US

(21) Appl. No.: 10/484,017

(22) PCT Filed: Jul. 29, 2002
(86) PCT No.: PCT/US02/23975

(30) Foreign Application Priority Data
Aug. 2, 2001 (US) 60309531

(51) Int. Cl. B05D 5/12; B05D 3/04

(52) U.S. Cl. 428/304.4; 427/307; 427/437; 428/323

(57) ABSTRACT

The present invention provides a process for forming inlaid patterns of metal into specified areas of a patterned substrate. The process, which is useful in the manufacture of semiconductor devices and circuits, comprises selectively removing seed layer from all surfaces save the trenches and vias and selectively electroless plating a metal into the patterned substrate where the seed layer remains. The present invention further provides an abrasive-free polishing-pad configured to planarize a metal plated surface, agitate chemical reagents and facilitate removal of gases generated by the electroless plating process.

### FIELD OF INVENTION

This invention relates to a process for forming inlaid patterns of metal on a substrate.

### BACKGROUND

The Damascene process is a back end of line semiconductor wafer manufacturing method used to create an inlaid pattern of metal interconnects within a patterned dielectric or barrier layer material. The Damascene process includes two process steps. In the first step, a blanket layer of metal about 1.5 micrometers thick is deposited on a substrate wafer using an electrolytic plating process. The blanket layer fills and covers the pattern in the substrate; that is, the vias and trenches, and the portion of the surface of the substrate that forms the outline of the pattern. In the second step, chemical mechanical polishing is used to remove excess metal from the substrate down to the surface of the patterned dielectric or barrier layer used to form the outline of the pattern. The polishing process yields an inlaid pattern of metal within the patterned dielectric or barrier material.

For advanced semiconductor devices utilizing the dual Damascene process, copper metal is used for the metal interconnects, silicon dioxide is used for the dielectric layer, and materials like tantalum or tantalum nitride are applied over the dielectric and are used for the barrier layers. Alternately, organic, semi-organic or other low-k dielectric material may be used.

Copper deposition onto a patterned barrier layer is a two-step process. First, a thin seed layer of copper 0.0 15 to 0.02 micrometers thick is deposited onto the patterned barrier layer by physical vapor deposition, chemical vapor deposition or electroless copper processes. Second, bulk copper is then deposited onto the seed layer of copper to a thickness of about O.'5 to 1.5 microns using an electroplating apparatus and process. The electroplated copper overfills the patterned barrier layer and must be removed by chemical mechanical planarization to form the final copper interconnects insulated by the dielectric and barrier layers on the substrate wafer.

Chemical mechanical planarization, CMP, is one process used to remove excess material from a surface. It typically includes the use of an abrasive along with passivating agents and/or chemical agents that either retard or assist the planning of material. It is useful in the manufacture of semiconductors as the patterned substrates onto which the material is deposited are essentially flat. By planing the plated patterned surfaces down to top-most surface of the substrate, only the portion of the material desired to comprise the interconnects or insulator remains. The term “planarizing” is used in the semiconductor industry as a synonym for liplaning.”

CMP may be used for planing portions of wafers comprising dielectrics, such as silicon dioxide, or metals, such as copper, aluminum or tungsten. In the copper CNLP processes, excess copper is planed or “polished” off from the top of the wafer surface to expose the thin pattered lines of copper metal inlaid within the barrier layer or substrate material. Copper CMP is performed by rotating a copper plated wafer in pressurized contact with a rotating polishing pad onto which with a liquid chemical oxidant and abrasive material are dispensed. Typical liquid oxidants for the copper CMP process include hydrogen peroxide and ferric chloride, and examples of typical abrasive slurry materials include approximately 0.01 micrometer diameter alumina or silica particles. Once the excess copper is removed by the polishing step, the wafer must be cleaned with additional chemicals and soft pads to remove the abrasive particles.

Problems with the current dual Damascene process include too much plating, “overplating,” of copper above the patterned barrier layer, the plated, but as yet un-planed, surface having uneven topography, and the planed surface having uneven topography. As to the planed surface, “dishing”, where the surface is not planar but rather concave, is a common problem as is the unwanted erosion of the plated wafer

The problem of overplating of copper on the substrate is solved by prolonged CMP processes to remove the excess copper and to planarize the wafer. This problem causes waste of expensive materials, copper and CMP slurry, and adds time to the manufacturing process, thereby reducing productivity and wafer throughput in addition to the added cost.

To create advanced semiconductor devices, those that contain multiple levels of metal lines and dielectrics, at a reasonable cost and in a commercially attractive size, increased wafer size and smaller features are required. These specifications make it increasingly difficult to fill the patterns with copper without creating gaps during the electrolytic plating processes. Such gaps are caused by the faster growth of copper deposits at the top edge of the patterns due to preferential deposition, resulting in enclosing of the patterns with voids insides the conductor, such voids often referred to as keyholes. Also, because the high electrical resistance of the thin copper seed layers across the substrate leads to substantial copper overplating, thicker copper seed layers are needed to completely fill in the patterns on the wafer substrate. However, a thicker seed layer increases the aspect ratio and can exacerbate the over-hang problems that lead to the creation of keyholes.

While prior art electroless copper plating processes or copper chemical vapor deposition processes may be used to overcome the electrical resistance problem, they do not eliminate the other defects mentioned hereinabove.

Another problem of CMP is the excess removal of substrate material from a wafer. Such excess removal during a CMP polishing step will cause deviations in wafer planarity that could result in wafer defects created in subsequent photolithographic or metalization steps. Polishing of metal surfaces using slurry-based chemical mechanical planarization also results in dishing: removal of metal from the interconnect below the top level of the barrier layer. Dishing causes an increase in the electrical resistivity of the copper interconnect because the conductor is thinner than it was designed to be. Increased resistivity can lead to overheating that will cause the semiconductor device to fail.

The excessive removal of metal and barrier materials from the patterned substrate using slurry based chemical mechanical planarization is called erosion. Erosion can lead to a non-planar topography across the wafer that can cause short circuits to form in subsequently deposited metal layers.

Additional problems with CNIP include scratching of fine line metal and dielectric features by the agglomerations of abrasive particles. Scratching results in damaged interconnects and yield loss. Agglomerated particles and gels can be removed from the slurries using point of use filtration prior to substrate polishing, however plugging of the filters requires interruption of the process for filter removal which is expensive and results in lower production. Agglomerated slurry particles also plug the surface of the polishing pad and polishing pads must be periodically reconditioned in a non-value added step called dressing.

As part of the chemical mechanical planarization process, cleaning of the wafers is also required to remove the abrasive particles from the polished wafer surfaces. Costly wafer cleaning tools are required to perform this operation. The added cleaning step increases production costs and decreases wafer throughput.

Chemicals and large amounts of water are required by the wafer-cleaning tool to remove the particles from the wafers leading to additional costs and added volumes of generated chemical waste.

In the prior art, typical copper CMP slurry solutions are composed of abrasive particles such as silicon oxide or ceria oxide, an oxidant such as hydrogen peroxide, a buffer, and a corrosion inhibitor such as benzotriazole. The mechanical action of the pad and abrasive removes the oxidized copper layer and exposes a fresh metal surface for further oxidation by the working liquid. The process repeats itself to remove the copper metal to achieve a planar surface. This method depends upon both mechanical and chemical actions for removal and, hence, referred to as chemical-mechanical planarization. The pressure between the abrasive pad and substrate is high and would be damaging to delicate low-k dielectrics. In order for the process to work, the pH and corrosion inhibitor of the solution is such that it does not chemically etch copper, which typically occurs at pH below 2.5 to 3.

Chemical mechanical planarization is a semi-batch process with one to four wafers being polished on a tool. This reduces the number of wafers which can be processed per hour. Additional chemical mechanical planarization polishing tools are expensive and require use of expensive and limited cleanroom space.

The copper plating of wafers is also performed in a semi-batch process on a plating tool. Up to six wafers are plated simultaneously on an electroplating tool. Electroplating tools are expensive to purchase and to operate because they require complicated robotics, in-line chemical monitoring, and expensive chemical reagents. Electroplating deposits copper over the entire substrate. This is undesirable since it leads to the requirement that the excess copper be removed from the plated wafers with chemical mechanical planarization. The polishing and plating tools limit the number of wafers that can be processed and decrease wafer throughput in the manufacturing facility. The cost of additional plating and polishing tools to increase wafer manufacturing production is expensive and such additional tools also require the use of expensive and limited cleanroom semiconductor manufacturing space.

U.S. Pat. No. 6,176,992 discloses a method for simultaneously depositing and polishing a conductive material on a semiconductor wafer. The method and apparatus of the invention uses either a slurry for polishing off copper or starves electrolytic solution from the top surface area of the semiconductor wafer by action of the polishing pad during the electroplating process. This method requires a tool that requires the use of expensive power supplies as well as complicated and expensive rotating anode and polishing pad assemblies. Such a tool would require the periodic replacement of both the anode and polishing pads. Replacement of such consumable items reduces tool uptime, limits productivity, and increases operational costs. Plating and polishing by the method of this invention is limited to a semi-batch or single wafer throughput because each wafer processed requires both a polishing wheel and an anode.

U.S. Pat. No. 6,004,880 discloses a process of depositing a conductive material on, and simultaneously polishing, a surface of an integrated circuit substrate. Such a process would require a tool that would need periodic replacement of both the anode and polishing pads which reduces tool uptime, limits productivity, and increases operational costs. This process also specifies the use of a slurry to polish the substrate during the plating process which can lead to scratches on the formed metal film. The use of a slurry during the CUT process will also contribute to dishing and erosion of the barrier layer which a problem common to all abrasive slurry chemical mechanical planarization processes.

U.S. Pat. No. 4,839,005 discloses a method and apparatus for applying a constant anodic potential to the surface of a substrate to dissolve surface metal while simultaneously performing mechanical polishing of the surface with an abrasive containing slurry. The invention teaches the removal of metal from a substrate by application of both polishing abrasive and electrolytic dissolution, however growth of a metal layer while polishing is not disclosed.

European Patent No. 1103346 describes an electrochemical mechanical method of polishing a substrate using a slurry but without the need for a chemical oxidizing agent. A time varying anodic potential is applied to the working piece to be polished. The method of this invention does not disclose an electrochemical plating or electroless plating process used in conjunction with the polishing method in order to build copper layer.

U.S. Pat. No. 6,117,775 discloses a polishing method for removing metal films from a substrate using chemical solutions and rubbing pads. However, the method does not teach the electroless plating of a metal into a previously polished patterned substrate. There exists a need in the semiconductor industry for a process to make fine copper interconnect lines inlaid on a patterned substrate that is comprised of dielectric or barrier layer materials. There is a further need that the metal deposition process reduces overplating and minimizes the need for chemical mechanical planarization to remove excess metal from the substrate. The metal interconnect lines and patterns formed by the process should be substantially free from dishing and the dielectric and barrier layers should be free from erosion. The process to make fine copper interconnect lines on a patterned substrate should be low cost and have a high throughput. It is further desirable that the process allows for integration of soft low k dielectric materials and a lower mechanical force on the wafer by the polishing pad.

### SUMMARY OF THE INVENTION

The present invention relates to a process of removing portions of a metallic seed layer that do not reside in the trenches and/or vias without damaging or etching the seed layer inside the trenches and/or vias. Subsequent to removal of the unwanted portions of the seed layer, an electroless plating solution is used to selectively deposit metal into the trenches and/or vias. The invention also relates to a process for filling the vias and trenches patterned on the substrate with the metal such that the vias and trenches are substantially the same height as the substrate at the end of the process without excess metal deposited on the top of the filled trenches and/or vias.

In a preferred embodiment, the substrate is a semiconductive material that is seeded with copper. It is first chemically etched by a selective chemical etching processes, then placed in the electroless plating solution to fill in the pre-defined patterns with electroless copper processes, then remove any excess copper on the top of the surface. Alternately, electroless plating while polishing of substrate is performed simultaneous or alternately so that metal deposition and planarization occur concurrently.

The present invention provides for selective electroless plating process for depositing and forming planar copper interconnects on a patterned substrate. The process of the present invention is advantageous in that it eliminates the need for costly electroplating equipment and produces copper interconnects free from dishing and erosion of the underlying substrate. A further advantage of the present invention is that it requires low pad pressures for the polishing step and is compatible with the processing of substrates containing delicate low k dielectrics. A further advantage of the present invention is that it does not contaminate the patterned substrate with abrasive particles that would be difficult to remove.

In one embodiment the present invention provides for a selective electroless plating process that deposits copper into vias and trenches formed on a patterned substrate. The substrate, including the patterned vias and trenches, is first coated with a seed layer of copper or other material that will activate the electroless deposition of copper. The seed layer not deposited in the trenches and/or vias is then selectively removed by a selective chemical or slurry-free chemical-mechanical processes, with the seed layer inside the pattern substantially intact. The selectively etched substrate with vias and trenches covered by copper seed layer are subsequently plated by catalytic deposition while in contact with the electroless plating solution until they are completely filled with the copper deposits. Such a process is termed a catalytic reaction because it allows for the spontaneous deposition of a metal film from an electroless plating solution only in the area where copper is present. If the seed layer is copper, such a reaction is deemed autocatalytic because the material being deposited is the same as that which is the catalyzer.

Because electroless plating is a chemical process, it does not require power supplies, consumable anodes, or expensive chemical monitoring and can be performed in a batch process. Electroless plating in a batch process significantly decreases the costs per wafer for the metalization step. A further advantage of the electroless plating process of this invention is that it can be limited to only those areas of the substrate that have been coated with the seed layer. This process further reduces the time needed for CMP as well as the chemicals that are consumed; wafer cleaning that is required and the copper waste that is generated. When the vias and trenches on the substrate are filled with copper to a height equal to or substantially the same as the barrier layer, plating is stopped. If desired, this plated substrate may be transferred to an abrasive free polishing station to remove metal from above the height of the barrier layer. Abrasive free polishing of the plated substrate continues until the height of the polished copper is at the desired level, such as the level of the barrier layer as determined by a polishing endpoint detection device.

In a preferred embodiment of the present invention, both the electroless plating and the abrasive free polishing process with the patterned substrate are performed in a single step. In this preferred embodiment, the mixing of electroless plating reagent and the concentration of gases in the electroless plating solution are controlled through the polishing pad.

### BRIEF DESCRIPTION OF THE DRAWINGS

FIG. 1(a) is an interferogram of a patterned substrate, Mode N, following polishing of a seeded patterned substrate utilizing the process of this invention.

FIG. 1(b) is an interferogram of the patterned substrate, Mode N, following electroless plating of the polished seeded patterned substrate utilizing the process of this invention.

FIG. 2(a) is an interferogram of a patterned substrate, Mode L, following polishing of a seeded patterned substrate utilizing the process of this invention.

FIG. 2(b) is an interferogram of the patterned substrate, Mode L, following electroless plating of the polished seeded patterned substrate utilizing the process of this invention.

### DETAILED DESCRIPTION OF THE INVENTION

This invention will be described in the following by reference to numerous specific details, materials, structures, chemicals and processes. In this detailed description, reference will be made to various figures where certain features are identified by reference numerals. Furthermore, although the preferred embodiment is described in reference to the copper deposition and polishing process described, it is appreciated that the copper deposition and abrasive free polishing process described are for exemplary purposes only and that techniques of the present invention can be readily adapted to other types of materials including other metals and alloys.

The present invention provides a process for plating a patterned barrier layer of vias and trenches on a substrate. For electroless plating of copper to occur, the substrate may require a patterned seed layer from 0.01 to 1 micrometers thick to activate the electroless plating process. In a preferred embodiment of this invention, copper is used as the seed layer. Patterned tantalum and tantalum nitride barrier layer substrates with copper seed layers are available from Sematech International, Austin, Tex. Examples of other suitable barrier layer materials used in copper interconnect structures include but are not limited to, Mo, TiW, TiN, WN, TiSiN, TaSiN and CoWP. A seed layer of copper material may be deposited onto these barrier materials by physical vapor deposition or by chemical vapor deposition. The seed layer of copper for electroless plating can also be deposited onto these barrier layer materials by the method of U.S. Pat. No. 6,225,221 or the method of U.S. Pat. No. 59674,787, both herein incorporated by reference in their entirety. Alternatively, the barrier layer surface may have a catalytic surface deposited to effect electroless copper plating. Examples of catalytic surfaces suitable for copper electroless plating include colloidal palladium as described in “Electroless Plating of Graphite with Copper and Nickel;” F. Caturla et al.; J. Electrochem. Soc., Vol 142, No. 12, December 1995; pp 4084-4090.

The patterned substrate containing the copper seed layer deposited on the barrier layer is treated by first polishing the entire wafer substrate with a polishing pad and a polishing solution. Polishing solutions useful in the practice of the current invention include hydrogen peroxide of concentration 1 to 5 percent by volume and containing an abrasive such as fumed silica or alumina from 0.5 to 10 percent by weight. The polishing step selectively removes copper from areas of the substrate other than the trenches and vias. Removal of the seed layer from areas other than the trenches and vias prevents electroless copper deposition onto these area and reduces the overplating and polishing that are needed in a typical electrochemical plating based on the dual Damascene processes.

In a preferred embodiment of this invention, the patterned substrate containing the copper seed layer deposited on the barrier layer is treated by first polishing the entire wafer substrate with a polishing pad and an abrasive-free polishing solution. In the present invention, an example of a useful abrasive-free polishing solution and polishing pad material for removing copper from a patterned substrate is disclosed in U.S. Pat. No. 6,117,775 and is herein incorporated by reference in its entirety. A polyurethane polishing pad from Rodel, Newark, Del., and a solution composed of citric acid and malic acids, a hydrogen peroxide oxidizer, and benzotriazole as an inhibitor all dissolved in water are used to remove copper from patterned substrates by this method. Other suitable polishing pads and chemical mixtures for removing copper from substrates in the present invention include fixed abrasive or three dimensional abrasive articles and buffered solutions as described in U.S. Pat. Nos. 5,692,950 and 6,238,592 B1 which are incorporated by reference in their entirety. Other suitable polishing pad materials include cation exchange membrane, for example CR67-HMR412 from Ionics, Watertown, Mass.

The linear velocity at which the wafer and polishing pad are rotated with respect to each other range from 0 to 500 cm/sec, more preferably from 100 to 200 cm/sec. Polishing can be performed by rotational, orbital, or linear motion of the polishing pad and wafer. Examples of such polishers include the Mirra Mesa orbital polisher from Applied Materials, San Jose, Calif., a SpeedFam-IPEC (SFI) Momentum orbital polisher, SpeedFam-IPEC Incorporated, Chandler, Ariz.

The pressure at which the wafer and polishing pad are contacted can range from 10 to 300 grams per square centimeter, 1 to 30 kilopascals, with a preferred pressure of from 10 to 60 grams per square centimeter, 1 to 30 kilopascals, or less. The rate at which the polishing solution is applied to the polishing pad should be sufficient to provide lubrication and reaction of the metal on the wafer. Dispense rates of polishing solution from 5 milliliters to 500 milliliters per minute, and more preferably from 10 milliliters per minute to 200 milliliters per minute can be used.

Polishing of the substrate continues until the metal is removed from the substrate. Endpoint detection of the metal removal polishing process can be made by measurement of temperature, motor current or by optical methods as described in “Full Wafer Endpoint Detection Improves Process Control in Copper CMP;” B. W. Adams et al.; Semiconductor Fabtech, 12^{th} edition, pp 283; and references therein.

After polishing, the patterned substrate containing the seed layer remaining on the barrier layer in the vias and trenches is treated by immersion or contact with an acid containing solution to remove excess inhibitor from the polishing step. Useful acids for cleaning the substrate include hydrochloric and methane sulfonic acid. A preferred acid is 10 percent by volume sulfuric acid at a pH of 0. The acid-cleaned substrate is washed with deionized water until water rinse from the coupon has a resistivity of between 10 and 18.2 mega ohms.

After washing to remove excess inhibitor and acid from the substrate, the patterned substrate containing the seed layer remaining on the barrier layer in the vias and trenches is treated by immersion in an electroless plating solution. The patterned substrate may be plated in a spray processor containing the electroless plating solution as disclosed in U.S. Pat. No. 6,065,424 and incorporated here in its entirety for reference. Alternatively, the patterned substrate may be plated in a sealed vessel as disclosed in U.S. Pat. No. 6,165,912.

The electroless plating solution for the process of the present invention consists of water, a source of copper ions, a reducing agent, a base, a complexing agent, and various surfactants. An example such solutions are disclosed in “Electroless Plating of Graphite with Copper and Nickel;” F. Caturla et al.; J. Electrochem. Soc., Vol 142, No. 12, December 1995; pp 4084-4090. Electroless plating solution are also commercially available from Shipley Company, Marlborough, Mass., or from Enthone-OMI, New Haven, Conn. Copper sulfate at a concentration of about 0.04 moles per liter is a preferred source of copper ions for electroless plating although other soluble copper salts like copper chloride, copper nitrate, copper sulfamate and copper hydroxide are also useful for electroless plating. Examples of reducing agents for copper electroless plating include formaldehyde at a concentration of about 0.2 moles per liter, though hypophosphoric acid, sodium hypophosphite, and diethylamine borane as disclosed in U.S. Pat. No. 6,193,789 B1, U.S. Pat. No. 4,279,948, and U.S. Pat. No. 4,877,450 respectively and incorporated here in their entirety are preferred reducing agents in copper electroless plating for environmental reasons. Examples of complexing agents useful in the practice of this invention include tetrasodium ethylene diamine tetraacetic acid at a concentration of about 0.12 moles per liter. Examples of bases useful in the practice of the current invention include alkali metal hydroxides, and ammonium hydroxide. Examples of surfactants useful in the practice of the current invention include polyethylene glycol, and Triton X-100™, Union Carbide, Danbury, Conn.

The patterned substrate containing the seed layer deposited on the barrier layer is treated in the electroless plating solution at a temperature of from 15 to 70 degrees Celsius, and preferably at a temperature from 25 to 35 degrees Celsius. The substrate is in contact with the plating solution for a time of between 1 minute and 60 minutes, and more preferably from 1 to 15 minutes. The solution containing the electroless plating solution and the substrate is agitated mix the solution and also to dislodge bubbles of hydrogen gas evolved from the electroless plating reaction that can inhibit metal plating onto the substrate.

The oxygen level in the bath is maintained at a substantially constant concentration to control the plating rate. The oxygen concentration for electroless copper plating can range from 0 to 40 parts per million by volume, the preferred concentration will depend upon the plating rate and process requirements. If necessary a purge of nitrogen gas can be used to remove dissolved oxygen from the electroless plating solution by sparging or bubbling.

The substrate treated with the electroless plating solution is removed from the solution and washed with deionized water. The plated substrate is washed with deionized water until water rinse from the substrate has a resistivity of between 10 and 18.2 mega ohms.

Metal deposited into the patterned trenches and vias by the electroless process is polished back to the height of the barrier layer using the abrasive free polishing pad and solution described above.

In a preferred embodiment of the present invention the patterned substrate containing the seed layer deposited on the barrier layer is treated with an electroless plating solution and simultaneously rubbed with a polishing pad over a part of its surface. The rubbing action of the polishing pad against the substrate while it is being plated will continuously dislodge gases from the substrate that are formed during the electroless plating reaction. The rubbing action of the pad will remove deposited metal from trenches and vias when the height of the metal in the trench or via exceeds the height of the barrier layer. The rubbing action of the polishing pad against the substrate can be started at any time during the plating process but is preferably initiated at the beginning of the plating process.

In a preferred embodiment of the present invention, the patterned substrate containing the seed layer deposited on the barrier layer is treated with an electroless plating solution and is simultaneously rubbed over a substantial portion of its surface with a polishing pad comprising a gas permeable membrane containing an embedded abrasive. The rubbing action of the gas permeable polishing pad against the substrate being plated will continuously dislodge gases from the substrate that are formed during the electroless plating reaction. In this preferred embodiment, the fixture holding the polishing pad against the substrate is connected to a conduit in communication with a vacuum pump. The vacuum pump removes gases, for example hydrogen and oxygen, from the interface between the substrate and the gas permeable abrasive containing polishing pad. The rubbing action of the abrasive containing gas permeable pad will remove deposited metal from trenches and vias when the height of the metal in the trench or via exceeds the height of the barrier layer.

The following example illustrates the present invention and is not intended to limit the same.

### EXAMPLES OF THE PRESENT INVENTION

The following procedures were employed in the testing of the referred herein.

Procedure 1

Patterned copper coupons from Sematech International, Austin, Tex., with 1.5 micrometer thick copper, 0.8 micrometer trenches, and pattern floor plan 926AZ-710 were used for copper electroless plating and polishing experiments. Square samples of the coupons, 2 centimeters on edge, were polished using a Buehler polishing wheel with down pressure of 60.8 grams per square centimeter provided to the back of the patterned coupon. Rotation of the polishing pad on the polishing wheel was 50 rotations per minute. The copper coupon to be polished was manually positioned on the rotating polishing pad and hand rotated at a rate of approximately 5 to 10 rotations per minute. The copper coupon was checked visually for copper removal at two-minute intervals. The polishing pad was 7.62 centimeters in diameter and composed of a surface modified microporous membrane of ultra high molecular weight polyethylene impregnated with cation exchange resin particles described in Procedure 2. Chemistry for polishing is described in Procedure 3 and was dispensed to the polishing pad at a rate of 10 milliliters per minute.

Procedure 2 (Polishing Pad Base Membrane Preparation)

A mixture consisting of UPE powder (240S, Mitsui), C-IEX (Microlite PrCH, Purolite) resin and mineral oil (Britol 35 USP, Witco) at a composition ratio of 1:7:9 by weight was prepared at room temperature. This mixture has a consistency of viscous slurry. It was mechanically homogenized and metered via a FMI pump (Fluid Metering Inc., model QV) into a twin-screw compounder (Brabender 05-96-000) equipped with a pair of 42 mm slotted counter-rotating screws (L/D=6). Melting and dissolution of UPE and dispersing of C-IEX particles occurred inside the compounder. A Zenith gear pump (Parker Hannifin 60-20000-0847-4), a static mixer (Koch Engineering, 2.5 cm. diameter×150 cm. length) and a flat sheet die with a slot opening of 17.8 cm in width were also attached downstream to the compounder for extrusion of the melt blend into sheet form. The temperatures of the various zones of the extrusion line were set at between 170° and 180° C.

The extruded sheet was quenched on a rotating chill roll whose temperature was controlled by recirculating constant temperature fluid at 70° C. Quenched gel sheet was rolled up by a motorized winder interleaved with a layer of polypropylene non-woven. To extract the mineral oil from the quenched sheet, the membrane roll was placed in a Baron-Blakslee degreaser containing 1,1-dichloro-1-fluoroethane for reflux extraction for 16 hrs. After extraction the porous membrane containing ultra high molecular weight polyethylene and cation ion exchange resin was dried at room temperature. Its thickness is ˜1 millimeter.

Surface Treatment

A strip of the base membrane was cut, pre-wet with isopropyl alcohol and immersed in DI water for conditioning before treatment. A monomer treatment solution consisting of 2-acrylarnido-2-methyl-1-propanesulfonic acid (Aldrich), N,N′-methylenebisacrylamide (Aldrich), 2-hydroxy-4′hydroxyethoxy-2-methylpropiophenone (Irgacure 2959, Ciba) and DI water at a composition of 5.4:1.3:0.3:97.0 weight ratio was prepared. The conditioned membrane was then soaked in this treatment solution for approximately 30 mins. The soaked membrane was sandwiched between 2 thin polyethylene films and lightly squeegeed to remove excess solution inside the sandwich. The sandwiched membrane was then exposed to ultra-violet radiation for initiation of reactions between the monomers on the membrane surface by passing it through an ultraviolet light Curing System (1300B with “H” bulb, Fusion Curing Systems) at a speed of 10 feet per minute. Afterwards, the treated membrane was removed from the sandwich and washed with DI water. This water-wet membrane was used as a rubbing pad for polishing.

Procedure 3

The polishing solution contained 4% hydrogen peroxide, 750 parts per million by weight benzotriazole, 300 parts per million by weight ammonium sulfate, and a buffer containing 8.4 millimolar ammonium acetate with acetic acid added to bring the solution to a pH of 4.1.

Procedure 4

The electroless plating solution contained 9.78 grams of copper sulfate pentahydrate, 45.44 grams of tetrasodium ethylene diaminetetraacetic acid, 19.88 grams of sodium sulfate, 20.33 grams of sodium formate, 8.8 milliliters of 400 molecular weight polyethylene glycol, and 9.83 grains of sodium hydroxide dissolved in deionized water and brought to a final volume of 1 liter. The solution was filtered through a 10-micrometer coarse glass frit and stored in a perfluoroalkoxy fluoropolymer (PFA) container.

### Example I

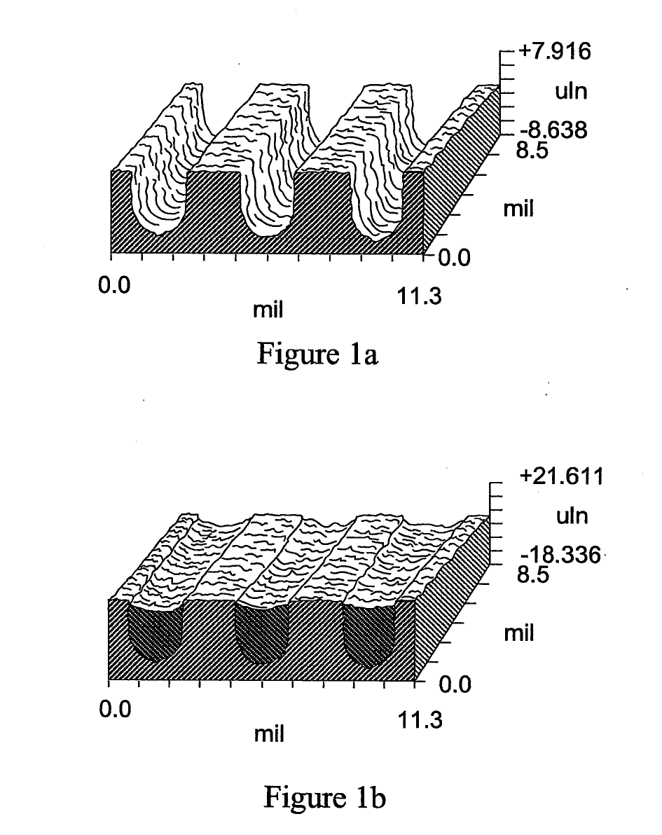

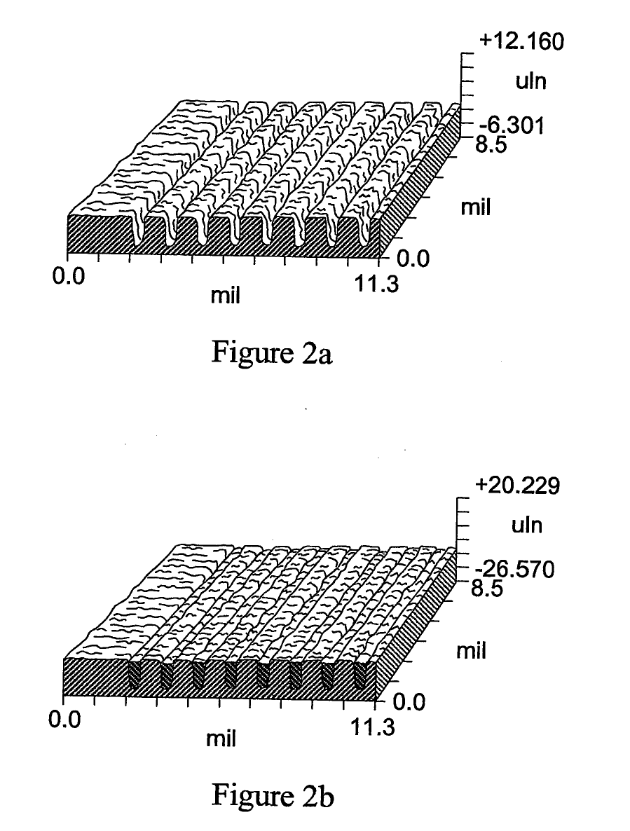

A seeded patterned copper coupon from Sematech with patterned floor plan 926AZ-710 and 1.5 micrometer thick copper and tantalum nitride barrier layer was planarized using about 6.1 kilopascals down force on a 7.62 centimeter diameter rubbing pad, prepared by the method of Procedure 2, rotated at 50 rotations per minute. Chemical polishing solution prepared in accordance with Procedure 3 was dispensed onto the rubbing pad at a rate of about 10 milliliters per minute. Polishing was stopped when all copper was removed from the portions of the barrier layer surface that did not include trenches. Interferometric analysis of the polished coupon was made using a Zygo Interferometer (Middlefield, Conn.) with a 50× objective lens. The patterns after polishing and labeled Mode N (50 micrometer line width, 100 micrometer pitch) and Mode L (10 micrometer line width, 20 micrometer pitch) on the 926AZ-710 floor plan are shown in FIG. 1(a) and FIG. 2(a), respectively. The trench depth is 0.87 micrometers to the bottom of the barrier layer without copper present. Interferometric analysis of line Mode N in FIG. 1(a) shows a polished trench depth of 0.33 micrometers which means that 0.54 micrometers of copper remains in the trench. Interferometric analysis of line Mode L in FIG. 2(a) shows a polished trench depth of 0.15 micrometers which means that 0.72 micrometers of copper remain in the trench. Copper was not observed on the top tantalum nitride surface.

After acid washing the polished coupon in 10 percent by volume sulfuric acid and rinsing with deionized water, copper was electroless plated onto the coupon using 26 milliliters of the electroless plating solution of procedure 4 to which was added 0.3 milliliters of 37% formaldehyde. The polished coupon and electroless plating solution were contacted in a 40-milliliter polyethylene beaker for a period of 30 minutes at 23 degrees Celsius with periodic agitation. The coupon was removed and washed with deionized water. Interferometric analysis of line Mode N in FIG. 1(b) shows a trench depth of 0.08 micrometers which means that about 0.24 micrometers of copper was deposited into the trench. No copper was observed on the barrier layer adjacent to the copper lines showing that copper could be selectively deposited. Interferometric analysis of line Mode L in FIG. 2(b) shows a trench height of 0.18 micrometers which about 0.32 micrometer of copper was deposited. Even though the plated copper protruded above the top tantalum nitride surface from the trench, no copper was deposited on the top tantalum nitride surface

1. A process for selectively depositing conductive material onto a seeded, patterned non-catalytic substrate, the process comprising:
a) selectively removing a catalytic seed layer from the top surface of the substrate with a composition which is free of an abrasive composition while the seed layer deposited within the patterned area remains substantially intact; and
b) selectively depositing a metal by catalytic reaction onto the remaining catalytic seed layer areas of the substrate.

2. The process of claim 1, wherein the seed layer is auto-catalytic.

3. The process of claim 1, wherein the substrate is a patterned dialectric with a non-catalytic barrier layer.

4. The process of claim 1 further comprising removing excess catalytically deposited metal from the substrate.

5. The process of claim 2, wherein the seed layer comprises copper or one of its alloys.

6. The process of claim 3, wherein said patterned dielectric substrate is silicon dioxide, or other dielectric material with a tantalum, a tungsten, or a titanium containing barrier layer.

7. The process of claim 1, wherein the removal of said seed layer metal from the substrate comprises rubbing the substrate with a polishing pad and a polishing solution containing chemical etchant and corrosion inhibitor, and optionally, buffering agents.

8. The process of claim 2, wherein said deposited metal is copper or copper alloy.

9. The process of claim 1, wherein said deposition process is an electroless plating process.

10. The process of claim 1, wherein said deposition process is an immersion process.

11. The process of claim 1, wherein the deposition process is a spray process.

12. The process of claim 1, wherein said seed layer removal occurs on an orbital polisher.

13. The process of claim 1, wherein said removal occurs on a rotational polisher.

14. The process of claim 1, wherein the said removal occurs on a belt polisher.

15. A non-abrasive pad used to remove metal from a substrate, the pad comprising cation exchange resin particles embedded within a matrix.

16. The pad of claim 15, wherein the matrix includes a porous membrane.

17. A polishing solution used in conjunction with a non-abrasive pad to remove metal from a substrate, the solution comprising an oxidant, a passivating agent and an acid or complexing agent.

18. A method for non-abrasively removing metal from a substrate, the method comprising rubbing a metalized substrate with a non-abrasive pad having cationic activity and exposing said substrate to a polishing solution.
